(19) United States
(12) Patent Application Publication
(10) Pub. No.: US 2022/0410707 A1
(43) Pub. Date: Dec. 29, 2022

(54) APPARATUS AND METHOD FOR CONTROLLING DISPLAY TYPE SWITCH FOR VEHICLE

(71) Applicants: HYUNDAI MOTOR COMPANY, Seoul (KR); Kia Corporation, Seoul (KR); LS Automotive Technologies Co., Ltd., Anyang-si (KR)

(72) Inventors: Jin Young KOH, Suwon-si (KR); Se Jun LIM, Incheon (KR)

(73) Assignees: HYUNDAI MOTOR COMPANY, Seoul (KR); Kia Corporation, Seoul (KR); LS Automotive Technologies Co., Ltd., Anyang-si (KR)

(21) Appl. No.: 17/675,348

(22) Filed: Feb. 18, 2022

(30) Foreign Application Priority Data
Jun. 24, 2021 (KR) 10-2021-0082529

(51) Int. Cl. B60K 35/00; B62D 1/04; H01H 23/14; H01H 23/00

(52) U.S. Cl. CPC B60K 35/00; B62D 1/046; H01H 23/14; H01H 23/006; B60K 2370/126; B60K 2370/1526; B60K 2370/42; B60K 2370/52; H01H 2231/026

(57) ABSTRACT

A display type switch for a vehicle includes a first display that displays one or more symbols related to functions of the vehicle and a second display that is connected to the first display and that controls the one or more symbols displayed on the first display.

### CROSS-REFERENCE TO RELATED APPLICATION

This application claims the benefit of priority to Korean Patent Application No. 10-2021-0082529, filed on Jun. 24, 2021 in the Korean Intellectual Property Office, the entire contents of which are incorporated herein by reference.

### TECHNICAL FIELD

The present disclosure relates to an apparatus and method for controlling a display type switch for a vehicle.

### BACKGROUND

In general, a steering column switch for operating a function of a vehicle has imprinted symbols indicating functions. Therefore, in the case of a vehicle model change or upgrade, a new steering column switch has to be produced. In this case, an amount of cost is taken to replace the existing steering column switch with the new steering column switch because the existing the steering column switch is removed and the new steering column switch has to be produced.

Even when a display type steering column switch is used, space-efficient switch design is required because the switch includes a display.

### SUMMARY

The present disclosure has been made to solve the above-mentioned problems occurring in the prior art while advantages achieved by the prior art are maintained intact.

An aspect of the present disclosure provides a switch for efficiently controlling a function of a vehicle through a display type steering column switch and a switch control method.

Another aspect of the present disclosure provides a space-efficiently designed steering column switch.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a display type switch for a vehicle includes a first display that displays one or more symbols related to functions of the vehicle and a second display that is connected to the first display and that controls the one or more symbols displayed on the first display.

According to an exemplary embodiment, the first display may include a first area and a second area. The one or more symbols displayed on the first area may include first symbols that represent the functions of the vehicle. The one or more symbols displayed on the second area may include second symbols that represent control states corresponding to the functions of the vehicle represented by the first symbols displayed on the first area.

According to an exemplary embodiment, the second display may be connected to the first display and may rotate.

According to an exemplary embodiment, at least one of the second symbols displayed on the first display may be selected based on a rotational direction and a rotation angle of the second display.

According to an exemplary embodiment, the rotational direction of the second display may include a first direction and a second direction. The first direction may be a clockwise rotational direction of a shaft that connects the first display and the second display. The second direction may be a counterclockwise rotational direction of the shaft.

According to an exemplary embodiment, the at least one of the second symbols may be selected based on a pointer displayed on the second area of the first display. The pointer may move to the at least one second symbol depending on the rotational direction and the rotation angle of the second display and may select the at least one of the second symbols in response to no manipulation of the second display for a preset period of time.

According to an exemplary embodiment, the second display may display information for identification of the selected at least one of the second symbols in response to the selection of the at least one of the second symbols.

According to an exemplary embodiment, the functions of the vehicle represented by the first symbols may include at least one of a headlight function or a wiper function of the vehicle.

According to an exemplary embodiment, the first display may be connected to a column switch. The column switch may include a connector that connects the first display, a circuit board that transfers a control signal to the first display, a tumbler switch that controls the first display, and a shaft that fixes the tumbler switch.

According to an exemplary embodiment, the circuit board may include a first face. The circuit board may further include a stationary contact and a travelling contact for the tumbler switch. The first face may include the stationary contact.

According to an exemplary embodiment, the shaft may include a second face. The second face may include the connector. A direction of a vector corresponding to a shortest line segment connecting the first face and the first display and a direction of a vector corresponding to a shortest line segment connecting the second face and the first display may be the same as each other.

According to an exemplary embodiment, the circuit board may include a flexible printed circuit board (FPCB).

According to another aspect of the present disclosure, a method for controlling a display type switch for a vehicle includes displaying one or more symbols related to functions of the vehicle on a first display and controlling the one or more symbols displayed on the first display, based on a second display connected to the first display.

According to an exemplary embodiment, the first display may include a first area and a second area. The one or more symbols displayed on the first area may include first symbols that represent the functions of the vehicle. The one or more symbols displayed on the second area may include second symbols that represent control states corresponding to the functions of the vehicle represented by the first symbols displayed on the first area.

According to an exemplary embodiment, the second display may be connected to the first display and may rotate.

According to an exemplary embodiment, the controlling of the one or more symbols displayed on the first display may include selecting at least one of the second symbols displayed on the first display, based on a rotational direction and a rotation angle of the second display.

According to an exemplary embodiment, the rotational direction of the second display may include a first direction and a second direction. The first direction may be a clockwise rotational direction of a shaft that connects the first display and the second display. The second direction may be a counterclockwise rotational direction of the shaft.

According to an exemplary embodiment, at least one of the second symbols may be selected by a pointer displayed on the second area of the first display. The selecting of the at least one of the second symbols displayed on the first display may include moving the pointer to the at least one of the second symbols based on the rotational direction and the rotation angle of the second display and selecting the at least one of the second symbols to which the pointer is moved, in response to no manipulation of the second display for a preset period of time.

According to an exemplary embodiment, the method may further include displaying information for identification of the selected at least one of the second symbols on the second display in response to the selection of the at least one of the second symbols.

According to an exemplary embodiment, the functions of the vehicle represented by the first symbols may include at least one of a headlight function or a wiper function of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a first display and a second display included in a display type switch for a vehicle according to an exemplary embodiment;

FIG. 2 illustrates a display type switch for a vehicle according to an exemplary embodiment;

FIG. 3 illustrates a symbol control process of a display type switch for a vehicle according to an exemplary embodiment;

FIG. 4 illustrates a structure of a display type switch for a vehicle according to an exemplary embodiment; and

FIG. 5 illustrates a method for controlling a display type switch for a vehicle according to an exemplary embodiment.

### DETAILED DESCRIPTION

Hereinafter, some embodiments of the present disclosure will be described in detail with reference to the drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

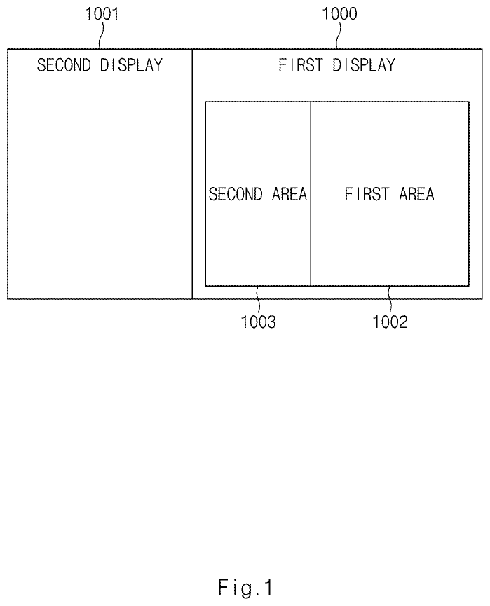

Hereinafter, embodiments of the present disclosure will be described in detail with reference to FIGS. 1 to 5.

FIG. 1 illustrates a first display and a second display included in a display type switch for a vehicle according to an exemplary embodiment.

FIG. 1 is a view illustrating the first display 1000 and the second display 1001 included in the display type switch for the vehicle according to the embodiment.

The display type switch (or, the switch) for the vehicle according to the embodiment may be a switch connected to a steering wheel of the vehicle. For example, the switch may be a steering column switch connected to the steering wheel of the vehicle to control a headlight function or a wiper function of the vehicle.

The switch according to the embodiment may include the first display 1000 and/or the second display 1001. The first display 1000 and the second display 1001 may be included in different modules, respectively, and may move independently of each other. The module including the first display 1000 and the module including the second display 1001 may be driven independently of each other, but may be connected with each other.

The first display 1000 may include a first area 1002 and/or a second area 1003. The first area 1002 and the second area 1003 may be display screens divided from each other in the first display 1000. The first area 1002 and the second area 1003 may each display one or more symbols.

The one or more displayed symbols may be symbols related to functions of the vehicle. That is, the symbols may be displayed in the form of icons related to the functions of the vehicle. For example, the functions of the vehicle represented by the symbols may include the headlight function, the wiper function of the vehicle, or the like.

The one or more symbols displayed on the first area 1002 may include first symbols representing functions of the vehicle. The symbols displayed on the second area 1003 may include symbols related to the functions represented by the symbols displayed on the first area 1002. Specifically, the one or more symbols displayed on the second area 1003 may include second symbols representing control states corresponding to the functions of the vehicle represented by the first symbols displayed on the first area 1002. For example, the second symbols displayed on the second area 1003 may represent an AUTO state and/or an OFF state corresponding to the headlight function of the vehicle represented by the first symbols.

The switch according to the embodiment may efficiently control the functions of the vehicle during travel through manipulation of the displays. Furthermore, the symbols representing the functions of the vehicle are not physically imprinted on the switch, but are output on the displays. Accordingly, in the case of a function update or a vehicle model upgrade, only the symbols output on the displays may be updated without replacement of the switch, and thus cost of replacing a part may be reduced.

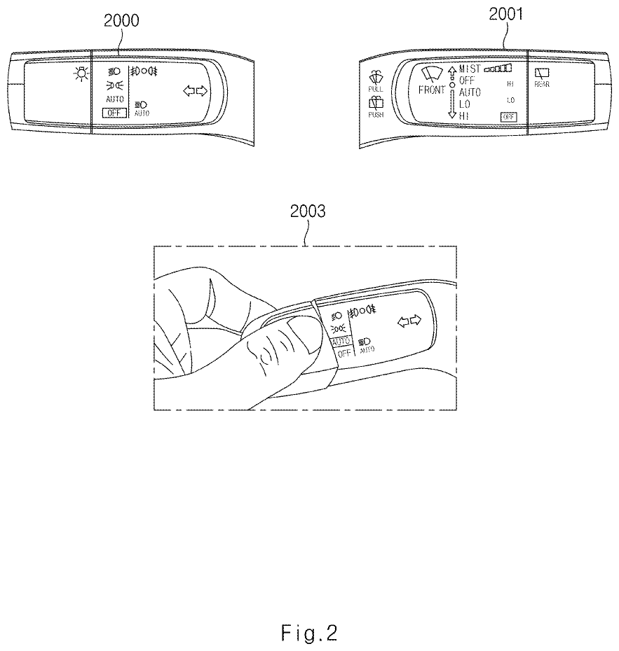

FIG. 2 illustrates a display type switch for a vehicle according to an exemplary embodiment.

FIG. 2 is a view illustrating the display type switch for the vehicle according to the embodiment (e.g., the above-described switch in FIG. 1).

As described above with reference to FIG. 1, the switch according to the embodiment may be a vehicle steering column switch. The vehicle may include two steering column switches (e.g., a left steering column switch and a right steering column switch).

Reference numeral 2000 may indicate the left steering column switch.

As described above with reference to FIG. 1, the steering column switches may include symbols related to functions of the vehicle. The left steering column switch 2000 may include symbols related to a headlight function of the vehicle. In this case, a first symbol may represent a headlight symbol, and a second symbol may represent a control state related to the headlight function. For example, the second symbol represents at least one of a low-beam state, a high-beam state, an AUTO state, an OFF state, or the like.

Reference numeral 2001 may indicate the right steering column switch.

As described above with reference to FIG. 1, the steering column switches may include symbols related to functions of the vehicle. The right steering column switch 2001 may include symbols related to a wiper function of the vehicle. In this case, a first symbol may represent a wiper symbol, and a second symbol may represent a control state related to the wiper function. For example, the second symbol represents at least one of a MIST state, an OFF state, an AUTO state, a LOW state, a HIGH state, or the like.

As described above with reference to FIG. 1, the switches may each include a first display and a second display, and the first display and the second display may be included in different modules, respectively, and may move independently of each other. Furthermore, the module including the first display and the module including the second display may be driven independently of each other, but may be connected with each other.

Control of the modules connected to the displays may mean control of the connected displays. Accordingly, a symbol displayed on the first display may be controlled by manipulating the second display.

For example, referring to reference numeral 2003, the second display may be connected to the first display and may rotate. That is, symbols (e.g., second symbols) displayed on the first display may be controlled by rotating the second display.

At least one of the second symbols displayed on the first display may be selected based on a rotational direction and a rotation angle of the second display. That is, a function of the vehicle may be controlled by selecting one of the second symbols on the first display by rotating the second display.

The switches may efficiently control the functions of the vehicle during travel through manipulation of the displays. Furthermore, the symbols representing the functions of the vehicle are not physically imprinted on the switches, but are output on the displays. Accordingly, in the case of a function update or a vehicle model upgrade, only the symbols output on the displays may be updated without replacement of the switches, and thus cost of replacing a part may be reduced.

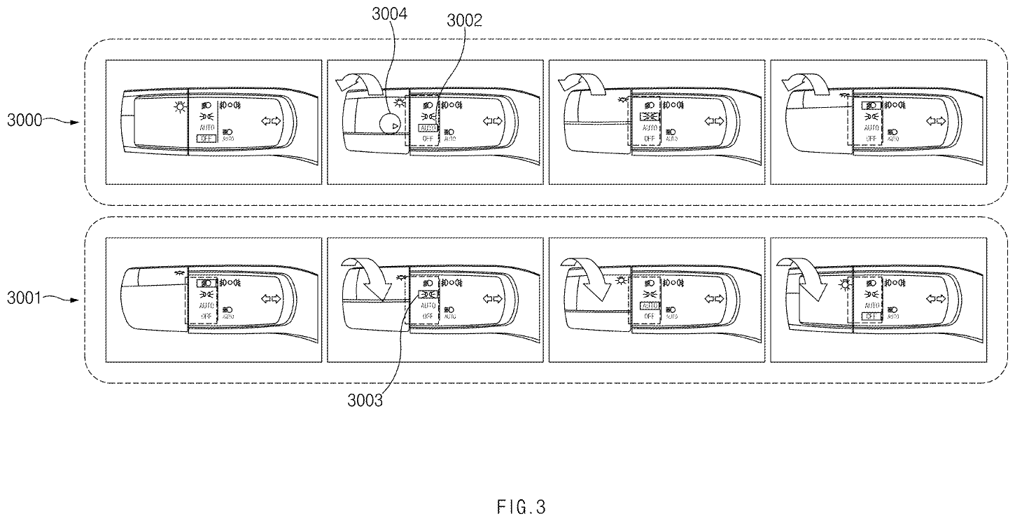

FIG. 3 illustrates a symbol control process of a display type switch for a vehicle according to an exemplary embodiment.

FIG. 3 is a view illustrating a process of controlling symbols (e.g., the first symbols and/or the second symbols in FIGS. 1 and 2) of the display type switch for the vehicle (e.g., the switches in FIGS. 1 and 2).

As described above with reference to FIG. 2, symbols (e.g., second symbols) displayed on a first display may be controlled by rotating a second display. Reference numerals 3000 and 3001 indicate processes of controlling the second symbols on the first display by rotating the second display.

As described above with reference to FIG. 2, at least one of the second symbols displayed on the first display may be selected based on a rotational direction and a rotation angle of the second display.

The rotational direction of the second display may include a first direction and a second direction. For example, the first direction is a clockwise rotational direction of a shaft connecting the first display and the second display, and the second direction is a counterclockwise rotational direction of the shaft connecting the first display and the second display.

Reference numeral 3000 indicates a process of selecting at least one of the second symbols on the first display by rotating the second display in the second direction.

At least one of the second symbols on the first display may be selected based on a pointer displayed on a second area of the first display. The pointer may move to at least one second symbol depending on a rotational direction and a rotation angle of the second display and may select the at least one second symbol in response to no manipulation of the second display for a preset period of time.

In response to a movement of the pointer to a specific second symbol, a display area displaying the specific second symbol to which the pointer is moved may represent the movement of the pointer through one or more methods. Furthermore, in response to selection of the specific second symbol, the display area displaying the selected second symbol may represent the selection of the second symbol through one or more methods.

For example, the display area displaying the second symbol to which the pointer is moved blinks, or the brightness of the display area is changed. Thereafter, in response to selection of the second symbol to which the pointer is moved, the display area displaying the selected second symbol is highlighted.

In another example, the display area displaying the second symbol to which the pointer is moved is highlighted. Thereafter, in response to selection of the second symbol to which the pointer is moved, the display area displaying the selected second symbol blinks, or the brightness of the display area is changed.

In still another example, the first display displaying the second symbols is connected with an audio, video, navigation (AVN) display in the vehicle and displays the movement of the pointer and the selection of the second symbol.

A method of representing the movement of the pointer and/or the selection of the second symbol is not limited to the above-described examples. Referring to the process 3000, when the pointer selects an OFF state, the second symbol representing the OFF state may be highlighted, compared to the other second symbols. In response to rotation of the second display in the second direction by a predetermined rotational angle, the pointer may move to the second symbol representing an AUTO state 3002. Thereafter, when a user (or, the driver of the vehicle) does not manipulate the second display for a preset period of time, the second symbol representing the AUTO state may be selected. The vehicle may perform a function corresponding to the selected second symbol.

Reference numeral 3001 indicates a process of selecting at least one of the second symbols on the first display by rotating the second display in the first direction.

Referring to the process 3001, when the pointer selects a low-beam state, the second symbol representing the low-beam state may be highlighted, compared to the other second symbols. In response to rotation of the second display in the first direction by a predetermined rotational angle, the pointer may move to the second symbol representing a high-beam state 3003. Thereafter, when the user (or, the driver of the vehicle) does not manipulate the second display for a preset period of time, the second symbol representing the high-beam state may be selected. The vehicle may perform a function corresponding to the selected second symbol.

In response to selection of at least one symbol, the second display may display information identifying the selected at least one symbol. For example, when the second symbol representing the AUTO state 3002 is selected as described above, the second display may display an arrow 3004 identifying the second symbol representing the AUTO state 3002.

The switch according to the embodiment may efficiently control functions of the vehicle during travel through manipulation of the displays. Furthermore, the symbols representing the functions of the vehicle are not physically imprinted on the switch, but are output on the displays. Accordingly, in the case of a function update or a vehicle model upgrade, only the symbols output on the displays may be updated without replacement of the switch, and thus cost of replacing a part may be reduced.

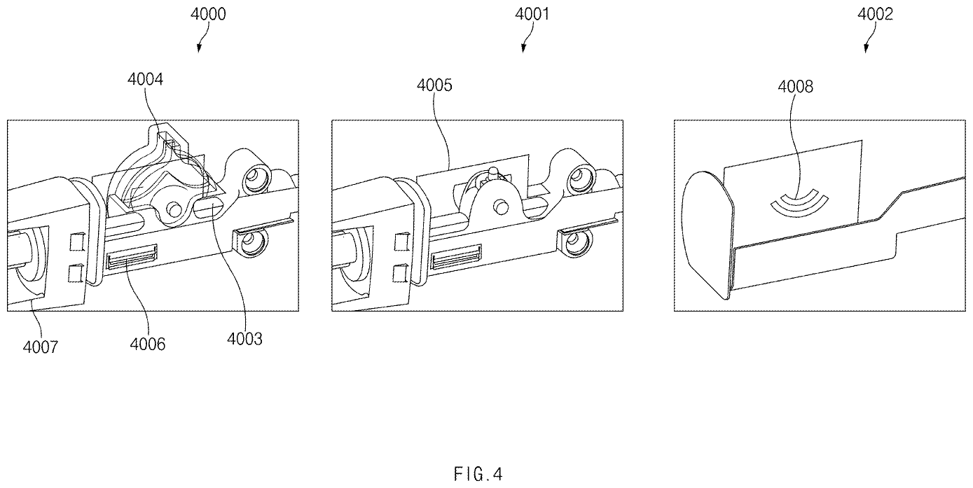

FIG. 4 illustrates a structure of a display type switch for a vehicle according to an exemplary embodiment.

FIG. 4 is a view illustrating the structure of the display type switch for the vehicle according to the embodiment (e.g., the above-described switches in FIGS. 1 to 3).

As described above with reference to FIG. 1, the switch according to the embodiment may include a first display and/or a second display. The switch may further include a column switch. The first display may be connected to the column switch. The column switch may include one or more modules for driving the first display.

Reference numeral 4000 indicates a view illustrating the column switch.

The column switch may include a connector 4006 connecting the first display, a circuit board 4005 for transferring a control signal to the first display, a tumbler switch 4004 for controlling the first display, and/or a shaft 4003 fixing the tumbler switch 4004. Reference numeral 4007 indicates a rotary switch that is included in the switch according to the embodiment and that connects the second display.

The circuit board 4005 may include a flexible printed circuit board (FPCB). Referring to a view 4002, the circuit board 4005 may be located to surround the shaft 4003 fixing the tumbler switch 4004. A face of the circuit board 4005 that faces the shaft 4003 may be referred to as a first face (that is, an inside face). That is, as in a view 4001, the first face may face the same direction as the connector 4006.

The connector 4006 may be located on the shaft 4003. A face of the shaft 4003 on which the connector 4006 is located may be referred to as a second face. That is, the first face and the second face may face the same direction.

The circuit board 4005 may further include a stationary contact and a traveling contact for the tumbler switch 4004 for driving the first display. When the stationary contact is printed on an opposite face (that is, an outside face) facing away from the first face, the stationary contact may be located to face away from the connector 4006. In this case, more parts may be required to drive the first display by rotation of the tumbler switch 4004, as compared with when the stationary contact is printed on the first face. That is, the space in the switch may be more efficiently used when the stationary contact is printed on the first face than when the stationary contact is printed on the opposite face that faces away from the first face.

To print the stationary contact on the first face and locate the connector 4006 such that the connector 4006 faces the same direction as the stationary contact, the second face of the shaft 4003 may include the connector 4006. That is, as illustrated in the view 4001 and the view 4002, the stationary contact and the connector 4006 may face the same direction.

As described above, the connector 4006 may be a connector for connecting the first display. When the stationary contact and the connector 4006 are located to face the same direction, the direction of a vector corresponding to the shortest line segment connecting the first face and the first display and the direction of a vector corresponding to the shortest line segment connecting the second face and the first display may be the same as each other.

The structure of the space in the switch may be most efficiently designed through the above-described method. That is, by ensuring efficiency in design of the space in the switch through the above-described method, the overall volume and/or weight of the switch may be reduced, and thus efficiency in producing the switch may be increased.

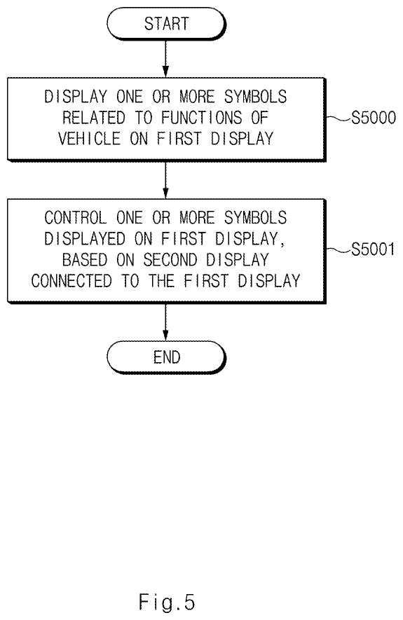

FIG. 5 illustrates a method for controlling a display type switch for a vehicle according to an exemplary embodiment.

FIG. 5 is a flowchart illustrating the method for controlling the display type switch for the vehicle according to the embodiment. The switches illustrated in FIGS. 1 to 4 may perform the method to be described below with reference to FIG. 5.

The method according to the embodiment may include step S5000 of displaying one or more symbols related to functions of the vehicle on a first display and/or step S5001 of controlling the one or more symbols displayed on the first display, based on a second display connected to the first display. Descriptions of the first display, the second display, and the symbols are identical or similar to ones given with reference to FIGS. 1 to 4.

The first display may include a first area and a second area, and one or more symbols displayed on the first area may include first symbols representing functions of the vehicle. One or more symbols displayed on the second area may include second symbols representing control states corresponding to the functions of the vehicle represented by the first symbols displayed on the first display. Specific descriptions of the first symbols and the second symbols are identical or similar to ones given with reference to FIGS. 1 to 4.

The second display may be connected to the first display and may rotate. Description of the rotation of the second display is identical or similar to ones given with reference to FIGS. 1 to 4.

Step S5001 may include a step of selecting at least one of the second symbols displayed on the first display, based on a rotational direction and a rotation angle of the second display. Description of the step is identical or similar to ones given with reference to FIGS. 2 and 3.

The rotational direction of the second display may include a first direction and a second direction. The first direction may be a clockwise rotational direction of a shaft connecting the first display and the second display. The second direction may be a counterclockwise rotational direction of the shaft connecting the first display and the second display. Descriptions of the first direction and the second direction are identical or similar to ones given with reference to FIGS. 2 and 3.

At least one of the second symbols may be selected by a pointer displayed on the second area of the first display.

The step of selecting at least one of the second symbols on the first display based on the rotational direction and the rotation angle of the second display may include a step of moving the pointer to at least one second symbol based on the rotational direction and the rotation angle of the first display and/or a step of selecting the at least one second symbol to which the pointer is moved, in response to no manipulation of the second display for a preset period of time. Descriptions of the steps are identical or similar to ones given with reference to FIG. 3.

The method according to the embodiment may further include a step of displaying information identifying the selected at least one second symbol on the second display in response to the selection of the at least one second symbol, and description of the step is identical or similar to one given with reference to FIG. 3.

The functions of the vehicle represented by the first symbols may include at least one of a headlight function or a wiper function of the vehicle. Descriptions of the functions of the vehicle are identical or similar to ones given with reference to FIGS. 1 to 4.

According to the embodiments of the present disclosure, a function of a vehicle may be efficiently controlled through the display type steering column switch.

Furthermore, according to the embodiments, the space-efficiently designed steering column switch may be provided.

In addition, the present disclosure may provide various effects that are directly or indirectly recognized.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A display type switch for a vehicle comprising:
a first display configured to display one or more symbols related to functions of the vehicle; and
a second display connected to the first display and configured to control the one or more symbols displayed on the first display.

2. The display type switch of claim 1, wherein the first display includes a first area and a second area,
wherein the one or more symbols displayed on the first area include first symbols configured to represent the functions of the vehicle, and
wherein the one or more symbols displayed on the second area include second symbols configured to represent control states corresponding to the functions of the vehicle represented by the first symbols displayed on the first area.

3. The display type switch of claim 2, wherein the second display is connected to the first display and rotates.

4. The display type switch of claim 3, wherein at least one of the second symbols displayed on the first display is selected based on a rotational direction and a rotation angle of the second display.

5. The display type switch of claim 4, wherein the rotational direction of the second display includes a first direction and a second direction,
wherein the first direction is a clockwise rotational direction of a shaft configured to connect the first display and the second display, and
wherein the second direction is a counterclockwise rotational direction of the shaft.

6. The display type switch of claim 4, wherein the at least one of the second symbols is selected based on a pointer displayed on the second area of the first display, and
wherein the pointer moves to the at least one of the second symbols depending on the rotational direction and the rotation angle of the second display and selects the at least one of the second symbols in response to no manipulation of the second display for a preset period of time.

7. The display type switch of claim 4, wherein the second display displays information for identification of the selected at least one of the second symbols in response to the selection of the at least one of the second symbols.

8. The display type switch of claim 2, wherein the functions of the vehicle represented by the first symbols include at least one of a headlight function or a wiper function of the vehicle.

9. The display type switch of claim 1, wherein the first display is connected to a column switch, and
wherein the column switch includes:
a connector configured to connect the first display;
a circuit board configured to transfer a control signal to the first display;
a tumbler switch configured to control the first display; and
a shaft configured to fix the tumbler switch.

10. The display type switch of claim 9, wherein the circuit board includes a first face,
wherein the circuit board further includes a stationary contact and a travelling contact for the tumbler switch, and
wherein the first face includes the stationary contact.

11. The display type switch of claim 10, wherein the shaft includes a second face,
wherein the second face includes the connector, and
wherein a direction of a vector corresponding to a shortest line segment connecting the first face and the first display and a direction of a vector corresponding to a shortest line segment connecting the second face and the first display are the same as each other.

12. The display type switch of claim 9, wherein the circuit board includes a flexible printed circuit board (FPCB).

13. A method for controlling a display type switch for a vehicle, the method comprising:
displaying one or more symbols related to functions of the vehicle on a first display; and
controlling the one or more symbols displayed on the first display, based on a second display connected to the first display.

14. The method of claim 13, wherein the first display includes a first area and a second area,
wherein the one or more symbols displayed on the first area include first symbols configured to represent the functions of the vehicle, and
wherein the one or more symbols displayed on the second area include second symbols configured to represent control states corresponding to the functions of the vehicle represented by the first symbols displayed on the first area.

15. The method of claim 14, wherein the second display is connected to the first display and rotates.

16. The method of claim 15, wherein the controlling of the one or more symbols displayed on the first display includes:
selecting at least one of the second symbols displayed on the first display, based on a rotational direction and a rotation angle of the second display.

17. The method of claim 16, wherein the rotational direction of the second display includes a first direction and a second direction,
wherein the first direction is a clockwise rotational direction of a shaft configured to connect the first display and the second display, and
wherein the second direction is a counterclockwise rotational direction of the shaft.

18. The method of claim 16, wherein the at least one of the second symbols is selected by a pointer displayed on the second area of the first display, and
wherein the selecting of the at least one of the second symbols displayed on the first display includes:
moving the pointer to the at least one of the second symbols based on the rotational direction and the rotation angle of the second display; and
selecting the at least one of the second symbols to which the pointer is moved, in response to no manipulation of the second display for a preset period of time.

19. The method of claim 16, further comprising:
displaying information for identification of the selected at least one of the second symbols on the second display in response to the selection of the at least one of the second symbols.

20. The method of claim 14, wherein the functions of the vehicle represented by the first symbols include at least one of a headlight function or a wiper function of the vehicle.
